(19) United States
(12) Patent Application Publication
(10) Pub. No.: US 2013/0173408 A1
(43) Pub. Date: Jul. 4, 2013

(54) System and Method for Dynamic Cross Publishing of Content Across Multiple Sites

(71) Applicant: Joakim F. Lindblom, Atherton, CA (US)

(72) Inventor: Joakim F. Lindblom, Atherton, CA (US)

(21) Appl. No.: 13/679,007

(22) Filed: Nov. 16, 2012

Related U.S. Application Data
(60) Provisional application No. 61/561,700, filed on Nov. 18, 2011.

(51) Int. Cl. G06Q 30/02

(52) U.S. Cl. CPC G06Q 30/0283; G06Q 30/0601
USPC 705/26.1

(57) ABSTRACT

Content from one site may be collaboratively linked and natively republished to another site for viewing and editing. Content cross-published is natively integrated within the target site taxonomy structure. Cross-published content can always be kept up to date, meaning that anytime the content is updated on the source site, any site that has the content cross-published to it automatically gets the updated content. If a user with permission sees the content on a re-published site and can edit the content directly without having to jump to the source site, and the content is automatically updated on all republished sites. In addition, authors have access to analytics for how the content is being used on all target sites. Authors of content may set policies for cross-publishing content.

This application is related to and claims priority from U.S. Provisional Patent Application No. 61/561,700 filed Nov. 18, 2011. Application 61/561,700 is hereby incorporated by reference in its entirety.

### BACKGROUND

1. Field of the Invention

The present invention relates to information management and more particularly to a system and method that allows content from one site to be dynamically republished on one or more other sites.

2. Description of the Prior Art

There is a longstanding desire and need to republish or otherwise syndicate content that resides on one site onto one or more other sites. The reasons for doing this include a) that high quality content is often difficult and expensive to produce, b) high quality content typically has multiple applications, c) high quality content deserves the broadest possible audience exposure, d) there is a desire to monetize high quality content across multiple applications and audiences and e) there are potential synergies that can emerge when content is shared between communities.

A prior art method for sharing content across multiple sites is to copy/paste or export/import content from one site to another. However, this method has several disadvantages, including 1) the labor and/or machine overhead involved, 2) the fact that if the source content is changed then it needs to be re-exported/imported to the syndicating sites, 3) there is no simple built-in mechanism for providing feedback and metrics from the syndicating sites, and finally 4) there is no built-in mechanism for permission request/granting and remuneration in accessing the content.

To address a subset of these issues, several types of content sharing protocols have been developed, most commonly utilizing Web Service type frameworks such as RSS (“Real Simple Syndication”) and Web APIs. While these protocols address issues (1) and (2) above, they do not address issues (3) and (4), and thus do not provide a complete solution for dynamic cross publishing of content across multiple sites. In addition, these systems do not provide static copies or ability to freeze versions of content when such functionality is desired (for instance, when an instructor teaching a class needs to temporarily freeze the content version of cross published content so it does not change while they are teaching the class).

It would be extremely advantageous to have a system whereby content can be cross published across multiple sites in a such a way that i) republished content automatically updates when the source content updates ii) there is an option for locking to a particular version of the content, iii) there is a simple and integrated request/approve permission mechanism for republishing content, iv) there is set policies for republishing, including options for free or for fee republishing, v) there is a built-in option for payment processing of content, either immediate or deferred based on viewership of republished content, vi) there is a simple way of copying the republished content and modifying it for a specific application, vii) there is a simple way for users with permission to modify the original content to do it from the republished content without having to go to the originating site, viii) there is a way of optionally sharing discussion threads, ratings and tags across all sites that republish the content, ix) there is a simple way to see from the originating site all of the sites that are republishing the content, x) there is a simple way to get consolidated metrics for traffic and usage for the content for all sites where it is republished, and xi) there is a simple way of revoking republishing privileges for any site that is using or misusing the content for a purpose that cause the originator's disapproval.

### SUMMARY OF THE INVENTION

The present invention relates to a system where content within a site located on a server and accessible over a network can be easily republished by a user onto another site such that the content is always kept up-to-date whenever the content on the originating site is updated. The content owner can to set policies for allowing cross-publishing content, including free, by permission only, and by purchase, all enabled and enforced by the system. The system enables the content owner to monitor how their content is being used, both in aggregate statistics and specific usage cases, as well as allows the content owner at any time to revoke cross publishing privileges in the aggregate or for any use-case they feel is inappropriate. In addition, the system allows discussions, ratings and tags about the content to be optionally shared across all sites where the content is republished. The system allows administrators and editors on the republishing site to lock the content to a particular version if they do not wish to receive automatic updates, and if the content owner's policy settings allow it, create a clone of the content which they then can modify. The system automatically detects if a visitor on the republishing site has editing privileges to the original source content, in which case the system displays additional elements to allow direct editing and other controls of the source content without requiring the user to return to the source site. Visitors viewing republished content on the republishing site have access to metadata available on the original content, plus republishing-related metadata, such as the original content site and a list of all other sites that the content is republished to (with the exception of private sites to which the visitor does not have access to). Visitors viewing republished content on the republishing site my also republish content to their own site, with the system enforcing all policies and permission requirements set by the owners of the source content. The system keeps track and makes sure that all links and metadata always refer back to the original source site, no matter how many steps removed from the original source the content is republished. When content is resold in this manner, the system keeps track of the revenue flow so that the owner of the content always gets reimbursed no matter how many steps removed the content is resold; the system also allows the content owner to set policies for their content whereby revenue is shared with the republishing site, all enabled and enforced by the system.

### DESCRIPTION OF THE FIGURES

Attention is drawn to several drawings that illustrate features in the present invention:

FIG. 1 shows one embodiment of a process by which content can be republished from one site to another.

FIG. 2 shows one embodiment of a user interface by which content can be republished from one site to another.

FIG. 3 shows a hierarchical stack that can support embodiments of the present invention.

FIG. 4 shows hardware the can be used to implement embodiments of the present invention.

Several drawings and illustrations have been provided to aid in understanding the present invention. The scope of the present invention is not limited to what is shown in the figures.

### DESCRIPTION OF THE PREFERRED EMBODIMENT

Dynamic cross publishing has several embodiments including distributed implementations relying on a Web services framework as well as multi-tenant cloud-based implementations. Distributed embodiments have the advantaged of supporting implementation on a wider variety of existing platforms, but may be more difficult to implement with the full feature set, and by its distributed nature requires data replication/caching on each server to guarantee high reliability. Multi-tenant cloud-based embodiments typically are more straightforward to implement with the full feature set and do not require data replication to achieve high reliability, but do require that all sites be on the same cloud-based implementation. A blended embodiment is also possible; whereby both distributed and cloud based implementations are supported.

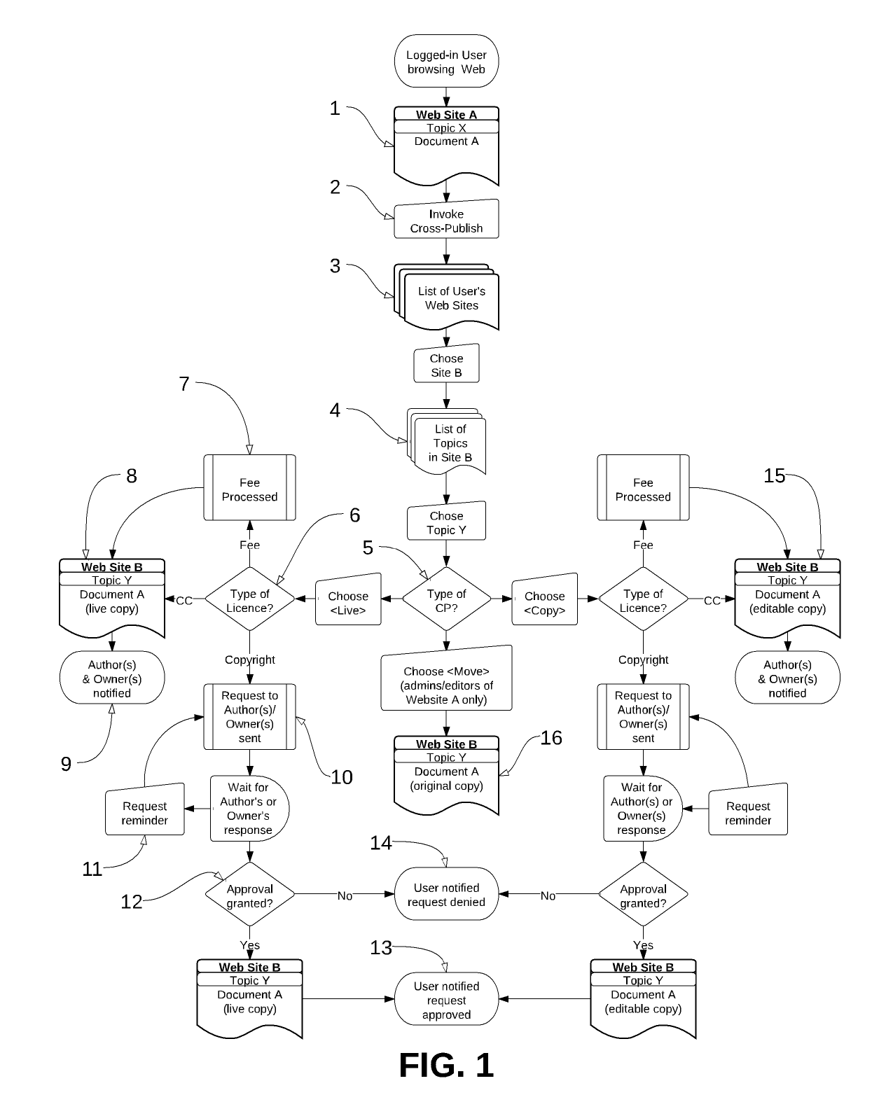

FIG. 1 shows the flow for how dynamic cross publishing is invoked and executed by a logged in user (i.e. a user who's identity is known). The user views a piece of content 1 on a site. The user invokes the cross publishing function 2 via an interface made available by the system. The system then displays a list of sites to which the user has editing privileges 3, whereby the user selects one of these sites. The system then displays the hierarchical list of topics (a.k.a. taxonomy) within that site 4, whereby the user selects one ore more of these topics (if the user selects multiple topics, the user has the option of designating one of these as “primary”, i.e. default). The system then displays a list of types of cross-publishing available to the user, based on a) the user's privileges on the source site, and b) the options allowed by the owner of the content. All users are presented with a “Live” option; if the user is an administrator of the source site, then the system presents a “Move” option as well; if the user is an administrator of the source site, an owner of the source content, or if the owner of the content specifically allows copying of the content, then the system also presents a “Copy” option. After the user selects the cross publishing option, the system follows different paths depending on the licensing option(s) imposed by the owner of the content 6. If the content is licensed under a free or open source license (such as a creative commons license), then the system immediately executes the cross publishing, and the content appears on the destination site with all appropriate metadata 8 in the case of “Live” cross-publishing, or 15 in the case of the “Copy” option, with the author(s) and owner(s) automatically notified by the system 9. If the content is under a copyright and there is a stated content cost, then the system automatically invokes the integrated ecommerce engine, resulting in the fee being automatically deducted from the user's account (or if sufficient funds are not available, the user is asked to fill their account with sufficient funds) and this fee (minus a processing fee) being credited to the content owner's account 7 (if the content is cross-published into a collection for resale, then the charge is deferred until the resulting collection is purchased by an end-user, and system keeps track of and credits collected revenue to each content owner whose content is part of the collection), before steps 8 and 9 are executed. In the case of content that is under copyright and there is no stated content cost, then system automatically sends a message to the content owner(s) asking for permission to cross-publish content 10: if the content owner approves the request 12, then the content is cross-published and the system sends an automated message to the user that the request has been approved 13; if the content owner rejects the request, then the system sends an automated message to the user that the request has been denied 14; if the content owner(s) does not respond in a timely manner, then the systems automatically sends out a reminder message after a set time to the content owner(s). Finally, if the user has administrator privileges to the site of the source content, then the user can elect to move the content 16 to the new site.

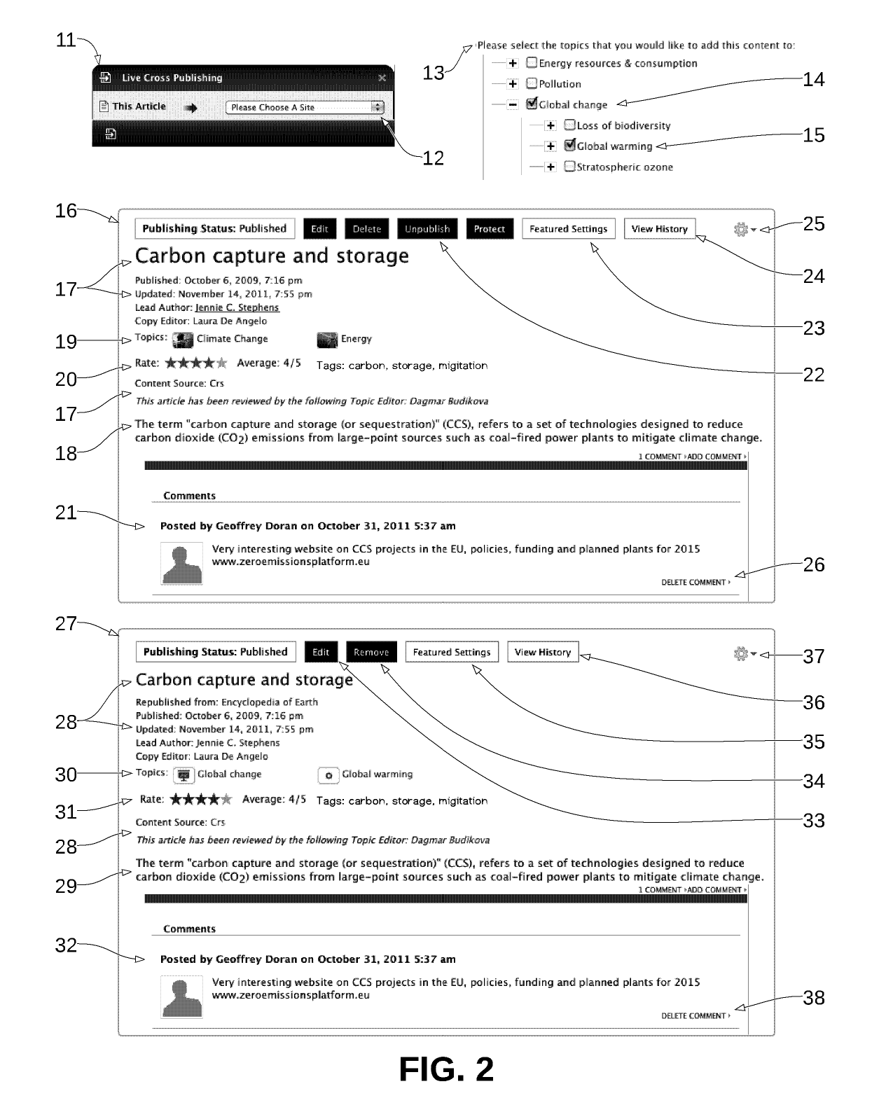

FIG. 2 shows an embodiment of the user interface for cross publishing and the display of the source and cross-published content respectively. The user initiates cross publishing from a toolbar 11 on the content source page 16, and selects the target site from a site selector 12 (automatically generated by the system based on the user's identity), listing all sites to which the user has editor or administrator access. Once the user selects a target site from this list, the system automatically pulls in the taxonomy from the target site 13, where after the user selects a primary taxonomic topic 14 and any number of secondary taxonomic topics 15 under which the cross-published content is to appear. The user then selects from a number of system generated cross publishing options (as described in FIG. 1), which initiates a sequence (also described in FIG. 1) that ultimately results in the source content 16 being cross published 27 to the target site. The source content display and cross-published content display shows content metadata 17 (title, dates authors, editors, sources) and main content 8 all visible wherever the content is republished 28, 29. Specific topic assignments 19 pertain to the taxonomy of the source site only, so these will be differ 30 when republished onto the target site, as decided by the user when cross publishing the content 13-15. User assigned ratings and tags 20 as well as the comment thread 21 may be optionally shared across some or all of the sites that to content appears on 31, 32. The core publishing controls 22 appear only next to the content on the source site, with the exception of the “Publishing Status” and “Edit” controls, which appear only on the cross-published content 33 if the user viewing it also has editing privileges to the source content. Cross-published content also has a “Remove” button 34, which allows cross-published content to be removed from the target site. Featuring controls 23, 35 pertain and apply only to the site on which the content appears. The content history 24, 36 can be viewed by administrators, editors and authors from both source and target sites, and allow administrators, editors and authors on the target site to optionally lock the content to a specific version so that cross-published content does not auto-updated every time the source content is updated. Additional tools available via drop down menu 25 on the source content include the ability to see all sites that the content is cross-published to, withdraw cross publishing privileges from some or all sites and view metrics on how the content is being used on cross-published sites. Additional tools available via drop down menu 37 on the cross-published content include the ability to see all sites that the content is cross-published to, view aggregate metrics on how the content is being used across all cross-published sites, and (if policies set by content owners allow) convert the cross-published content to a copy so that it can be edited independently of the source content. Comments can be moderated 26 both from source site, as well as from the target site 38 in the case of comments added directly to the cross-published content.

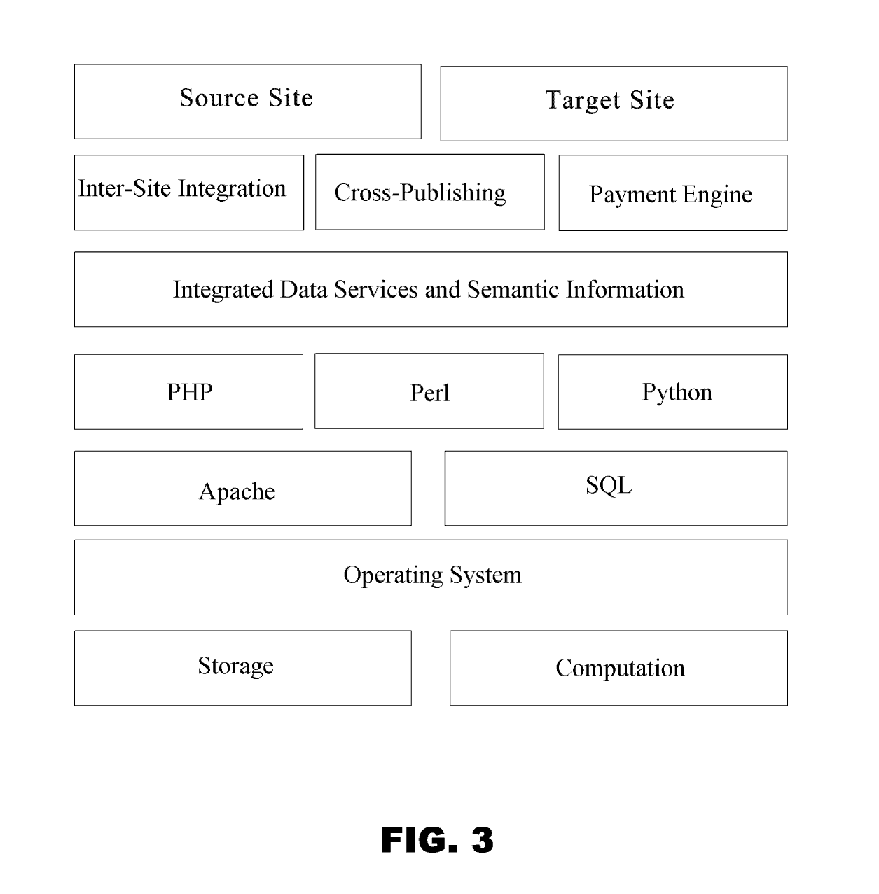

This invention may be implemented in hardware and software in several ways. What follows is a description of the preferred embodiment. FIG. 3 illustrates an embodiment of a logical software stack. The source and target sites are implemented in the application layer, and comprise a collection of content entries (articles, images, videos and other content objects) that are implemented as resources within the data services information core. The resources are attached to one or more topic objects, which also exist in the information core. The topic objects are organized hierarchically, which serves to define the site organization and scope. The information core in turn is defined as software objects (in this embodiment coded in the PHP, PERL an Python programming languages) and database objects (in this embodiment implemented within a SQL database). When user sets up the structure and scope of a site (such a knowledge collection), they activate software within the dynamic taxonomy software code module, which in turn defines scope, organization, hierarchy and user permissions with the database. When a user cross-publishes content from another site on the platform, they activate the Cross Publishing software module as well as (optionally if the content has a set price) the ecommerce software engine. The system keeps track of access permissions and content ownership within the database, which determines what options, process flow, and controls are available to the user as described in FIGS. 1 and 2. All of these software and database components are run on servers supported by an operating system (such as Linux or any other operating system) and Web server software (in this embodiment Apache), which receives and sends data to devices on the network, including user computers as well as servers.

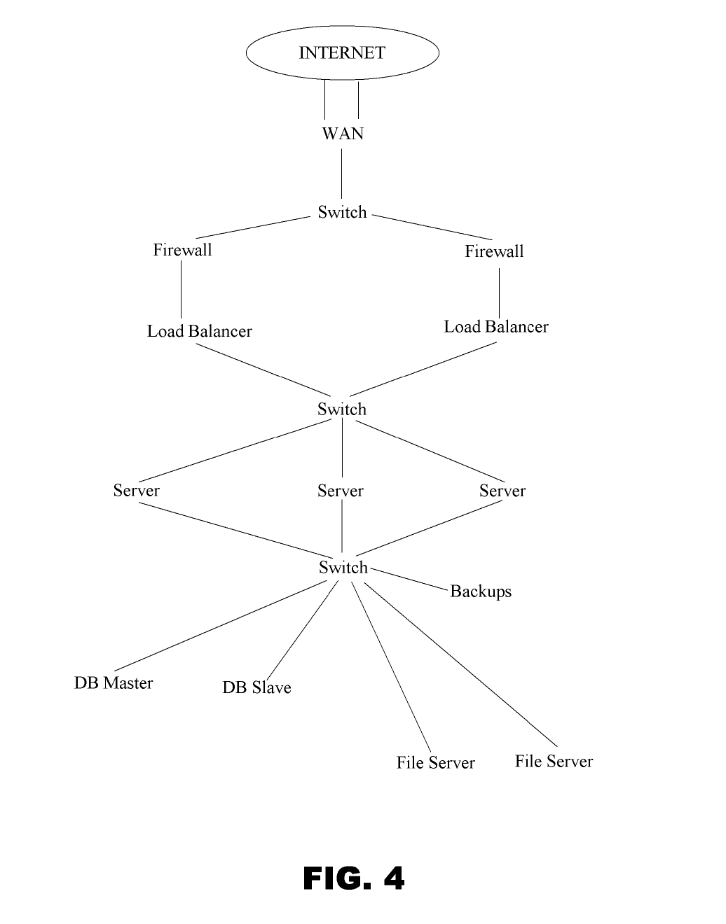

FIG. 4 illustrates a single server farm belonging to a network architecture that can implement the software stack and network functionality. In this embodiment, a request for data or other transaction originates from users' computers on the Internet. The request gets routed to one or more redundant server farms on the Internet such as the one shown in FIG. 4. When the request arrives at a server farm, it gets routed through a firewall and then to one or more application servers through a load balancer. The application server in turn makes the software calculations (using the above software stack), and determines whether data and/or logic action requests exist in the cache. If it exists in the cache, it gets immediately sent to the client computer via the same devices (but in opposite direction) from which the original request was made. If the data and/or logic does not exist within the cache, then the application server makes a request for the data and/or logic from either the database server and/or the file server, depending on what kind of request is involved. The result of this request is (1) routed up the chain of devices and connections so that it arrives back at the client computer on the Internet that made the original request, and (2) stores the result of the request in the cache so that the next time the same request is made (within a time limit specified) the result can be served from the cache without involving either the database and/or file server, thus speeding performance.

Several descriptions and illustrations have been presented to aid in understanding the present invention. One with skill in the art will realize that numerous changes and variations are possible without departing from the spirit of the invention. Each of these changes and variations is within the scope of the present invention.

I claim:

1. A dynamic cross-publishing system located on a platform on at least one server and accessible over a network by a plurality of users comprising:
a plurality of content storage areas on said platform wherein authors can enter, change and update content as well as setting prices associated with said content;
user access support wherein a user can cross-publish content from an originating site onto a different site as well as dynamically updating said content;
management support which stores said source content and cross-published content;
administrator, author and user access support adapted to allow individuals to create, upload, set policies, cross publish and monitor said source content and/or said cross-published content.

2. The dynamic cross-publishing system of claim 1 wherein content on said different site is kept up-to-date whenever the content on the originating site is updated.

3. The dynamic cross-publishing system of claim 1 wherein a content owner can to set policies for allowing cross-publishing of content, including free, by permission only, or by purchase.

4. The dynamic cross-publishing system of claim 1 wherein the content owner can monitor how particular content is being used.

5. The dynamic cross-publishing system of claim 1 wherein a content owner can revoke cross-publishing privileges for particular content.

6. The dynamic cross-publishing system of claim 1 wherein discussions, ratings and tags about content to be optionally shared across all sites where the content is published.

7. The dynamic cross-publishing system of claim 1, wherein the system assures that all links and metadata for particular content always refer back to said originating site, no matter how many far removed from the originating site is the site where said content is published.
